(19) United States
(12) Patent Application Publication
(10) Pub. No.: US 2008/0030305 A1
(43) Pub. Date: Feb. 7, 2008

(54) Systems and Methods for Using a Tag

(76) Inventor: Ruaidhri Manfried O'Connor, Cambridge, MA (US)

Correspondence Address: CHOATE, HALL & STEWART LLP, TWO INTERNATIONAL PLACE, BOSTON, MA, 02110, US

(21) Appl. No.: 11/749,537

(22) Filed: May 16, 2007

Related U.S. Application Data
(60) Provisional application No. 60/827,689, filed on Sep. 30, 2006.
(60) Provisional application No. 60/747,304, filed on May 16, 2006.

(51) Int. Cl. H04B 7/00

(52) U.S. Cl. 340/10.1

(57) ABSTRACT

Systems and methods for using a tag are shown and described. The tag can include a photovoltaic module and an RF module. The photovoltaic module receives an impinging optical transmission and converts at least a first portion of the optical transmission into electrical energy and a second portion of the optical transmission into data. The RF module communicates directly or indirectly with the photovoltaic module. The RF module receives the electrical energy from the photovoltaic module and in response modifying a characteristic of the RF module to generate a backscatter modulation signal.

### FIELD OF THE INVENTION

This application generally relates to systems and methods for identification. In particular, this application relates to systems and methods for identification using a tag.

### BACKGROUND OF THE INVENTION

An example of an Automatic Identification technology is a system consisting of Radio Frequency Identification (RFID) tags and a RFID reader. Another example is bar code labels (tags) and bar code reader.

In the technical field of Automatic Identification technology the tags are categorized according to the means by which the tag is powered, and the means by which the tag transmits data with the reader. Specifically the tags are categorized as follows:

Passive: meaning the tag operates solely by harvesting power from the reader signal. There is no active (i.e., local) power source, for example a battery. The harvested power is not used to directly communicate with the reader rather a process such as a backscatter modulation method is used wherein the tag reflects the readers signal and represents data by changing the impedance of the antenna, thus modulating the reflected signal.

Semi-Active: meaning the tag contains an active (i.e., local) power source, such as a battery. The tag uses this power source to operate solely the internal processing function of the tag. The tag does not operate a dedicated transmitter to communicate with the reader rather a method such as backscatter modulation is used wherein the tag reflects the readers signal and represents data by changing the impedance of the antenna, thus modulating the reflected signal.

Active: meaning the tag both contains an active (local) power source, such as a battery, and uses this power source to both operate the internal processing function of the tag and operate a dedicated transceiver to communicate with the reader.

### SUMMARY OF THE INVENTION

In one aspect, the disclosure is directed to a tag that includes a photovoltaic module and an RF module. The photovoltaic module receives an impinging optical transmission and converts at least a first portion of the optical transmission into electrical energy and a second portion of the optical transmission into data. The RF module communicates directly or indirectly with the photovoltaic module. The RF module receives the electrical energy from the photovoltaic module and in response modifying a characteristic of the RF module to generate a backscatter modulation signal.

In one embodiment, the characteristic of the RF module includes the impedance of an antenna. In another embodiment, the tag also includes a processor that communicates with the photovoltaic module and the RF module. The processor receives at least a portion of the electrical energy and in response executes instructions to control the characteristic of the RF module. In a further embodiment, the processor is an application specific integrated circuit.

In further embodiments, the tag includes one or more sensor modules that communicate with the processor, one or more signal detection modules that communicate with the processor and detect the presence of a signal. Also, the tag can include a memory module that communicates with the processor.

In another aspect, the disclosure features a method of operating a tag. The method can include converting, by a photovoltaic module, at least a first portion of a received impinging optical transmission into electrical energy and at least a second portion of the received impinging optical transmission into a data signal and receiving, by an RF module, the electrical energy. The method also can include modifying a characteristic of the RF module to generate a backscatter modulation signal.

In one embodiment, modifying a characteristic of the RF module includes modifying an impedance of an antenna of the RF module. In another embodiment, the method can also include demodulating the data signal.

In yet another embodiment, the method also includes receiving, by a processor module in communication with the photovoltaic module and the RF module, at least a portion of the electrical energy and executing instructions to control the characteristic of the RF module. In a further embodiment, executing instructions includes executing instructions stored in a memory module of the tag by and application specific integrated circuit of the tag.

In still another embodiment, the method includes sensing a characteristic of an environment in which the tag is deployed. Also, the method can include detecting the presence of a signal prior to the modifying the characteristic of the RF module.

In still another aspect, the disclosure features a system for operating a tag. The system includes means for converting at least a first portion of a received impinging optical transmission into electrical energy and means for converting at least a second portion of the impinging optical transmission into a data signal. The system also includes means for receiving the electrical energy and means for modifying a characteristic of the RF module to generate a backscatter modulation signal.

In one embodiment, the means for modifying includes means for modifying an impedance of an antenna of the RF module. The system can also include means for executing instructions to control the characteristic of the RF module. In a further embodiment, the system also includes means for storing instructions.

In yet another embodiment, the system includes means for sensing a characteristic of an environment in which the tag is deployed. In still another embodiment, the system includes means for detecting the presence of a signal prior to the modifying the characteristic of the RF module.

### BRIEF DESCRIPTION OF THE DRAWINGS

The following figures depict certain illustrative embodiments of the invention in which like reference numerals refer to like elements. These depicted embodiments are to be understood as illustrative of the invention and not as limiting in any way.

FIG. 1 depicts an embodiment of an environment of operation of an identification system;

FIG. 2 shows a block diagram of an embodiment of a reader for use in an identification system;

FIG. 3 shows a block diagram of an embodiment of a tag for use in an identification system; and

FIG. 4 is a flow chart of a method of using a tag.

### DETAILED DESCRIPTION

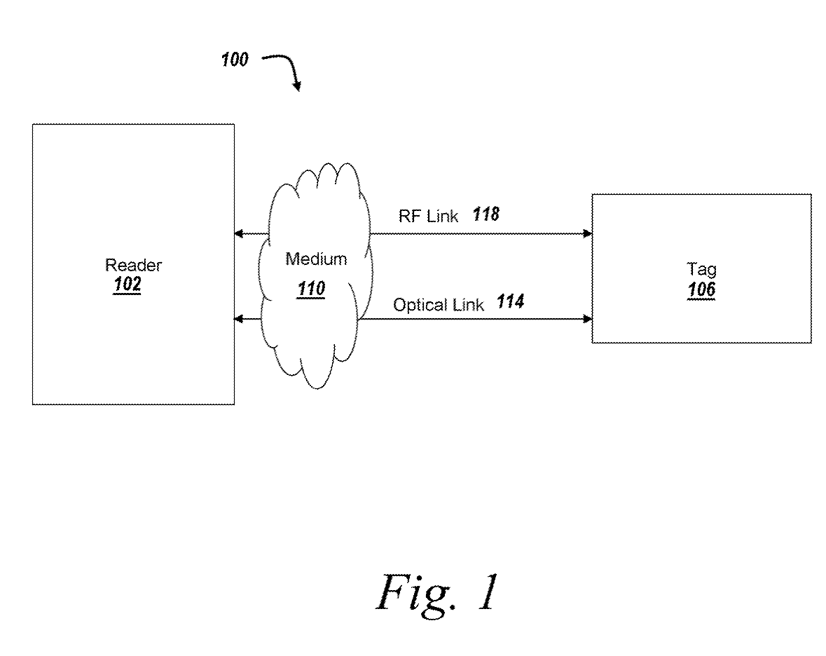

With reference to FIG. 1, an environment 100 for providing identification of objects includes a reader 102 and tag 106 that communicate with one another through one or more mediums 110. In one embodiment, the reader 102 communicates with the tag 106 using, alone or in combination, an optical communications link 114 and a radio frequency (RF) link 118. The medium can be free space or some other medium capable of supporting communication between the reader 102 and the tag 106 over a variety of frequency ranges.

The reader 102, in some embodiments, transmits data and power to the tag 102 using an optical carrier wave (i.e., a beam of light that may or may not be visible and includes the plurality of light wavelengths that are usefully received by a plurality of photovoltaic materials). The data can be modulated onto the optical carrier wave. The tag 106 receives the optical transmission and demodulates the data. In turn, the data is stored within a memory component of the tag 106 for later use. For example, at a later time, the reader 102 interrogates the tag 106 with a beam of light, which cause a photovoltaic substrate to “power-up” the tag 106, detect any modulation of the light signal, interpret the modulation as a digital encoding of data, and provide a backscatter response in an RF frequency band. Further details and examples are described below.

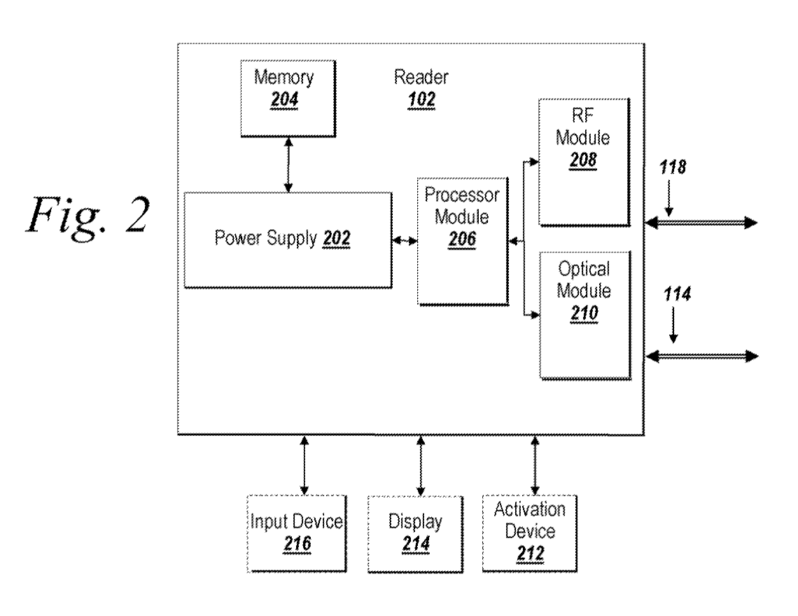

With reference to FIG. 2, an embodiment of the reader 102 is shown and described. The reader, in one embodiment, includes a power supply 202, a memory module 204, a processor 206, an RF module 208 and an optical module 210. In some embodiments, the reader 102 includes an activation device 212, a display module 214, and an input device 216. In other embodiments, various combinations of all or some of the above-mentioned components are included in the reader 102. Also, additional components that are not shown and described can also be included.

The power supply 202 is in communication with the memory 204, the processor 206, the RF module 208, and the optical module 210. In one embodiment, the power supply 202 is a DC power supply. For example, the power supply can include DC-DC converter circuitry. In another embodiment, the power supply 202 is an AC power supply. For example, a switched-mode power supply can be used.

In operation, the power supply 202 provides a means to operate the other components of the reader 102. For example, the power supply 202 provides power to the processor 206 so that the processor can operate as needed.

The memory module 204, in one embodiment, includes a volatile memory. In another embodiment, the memory module 204 includes, alone or in combination, one or more memory storage mediums such as an EEPROM, a ROM, a PROM, a RAM, a SRAM, a FRAM, a MRAM, and the like.

The processor module 206, in one embodiment, communicates with the RF module 208 and the optical module 210. The processor 206 can be any type of general purpose processor core, dedicated processor, dedicated finite state machine (FSM), Field Programmable Gate Array, or application specific gate logic. For example, the processor 206 can be a digital signal processor. The processor 206 executes instructions that are stored in a memory module 204 or memory external to the reader 102 These instructions, when executed, cause the processor to co-operate with the other modules of the reader 102 to provide functionality described below in more detail.

The RF module 208 communicates with the processor 206 and the power supply 202. Also, in some embodiments, the RF module communicates with the memory module 204. The RF module 208 includes digital signal processing circuitry, analog circuitry and an antenna. The RF module 208 emits a RF signal through the antenna that is used to power a portion of the circuitry on the tag 106, transmit encoded data to the tag 106 using the emitted RF signal as a carrier frequency, and uses one or more modulation schemes (e.g. Amplitude Shift Keying (ASK), Frequency Shift Keying (FSK) and related schemes). Data transmitted on the carrier signal is structured using an encoding representation (e.g. Manchester Encoding and the like). In the embodiment of the reader 102 RF module 208 there will be circuitry and software support to detect the reflected back-scatter signal and interpret said signal as data from the tag 106

The tag 106 contains a RF antenna that is tuned to the frequency of the RF module's 208 emitted signal whereby RF signals from the reader 102 are detected and reflected by the tag 106 in a way that the RF module 208 can detect the reflected signal. This process is called carrier wave backscatter modulation.

The optical module 210 also communicates with the processor 206 and power supply 202. Also, in some embodiments, the optical module 210 also communicates with the memory module 204 through the processor module 206. In one embodiment, the optical module includes one or more light emitting diodes (LEDs). The optical module 210 emits light with a measure of radiant energy sufficient to activate one or more photovoltaic materials such as silicon, cadmium telluride, gallium arsenide, semiconductor organic polymers, and the like. In other embodiments the optical module 210 includes concentrating optics (e.g. focusing or collimating lenses or reflectors and the like).

In operation, the optical module 210 acts as a light source and provides alone, or in combination with the other modules of the reader 102, a means to encode and transmit digital data wirelessly to the tag 106. In one embodiment, the digital data is provided to the tag 106 as a modulated light waveform. Various forms of modulation, such as, amplitude modulation and phase modulation can be used. In other embodiments, other modulation schemes are used. The optical module 210 modulates the emitted light using one or a combination of optical modulation devices such as electro-optic, acousto-optic, mechanical shuttering and the like. In one embodiment, the optical module 210 emits light at a wavelength in the range of about 400 nm to 1400 nm. In some embodiments, the before mentioned range can be considered the range of wavelengths that encompasses visible light. The optical module 210 can be modulated to initiate a timing cycle to define a desired communication window

In one embodiment, the reader 102 is provided in a hand-held form factor and is portable. In such an embodiment, the reader 102 can be in the form of a gun that includes a trigger mechanism that when activated causes the interrogation of the tag 106. In other embodiment, the reader 102 is provided in a different form factor. For example, the reader can be stationary and affixed to a surface such as a doorway or loading dock door.

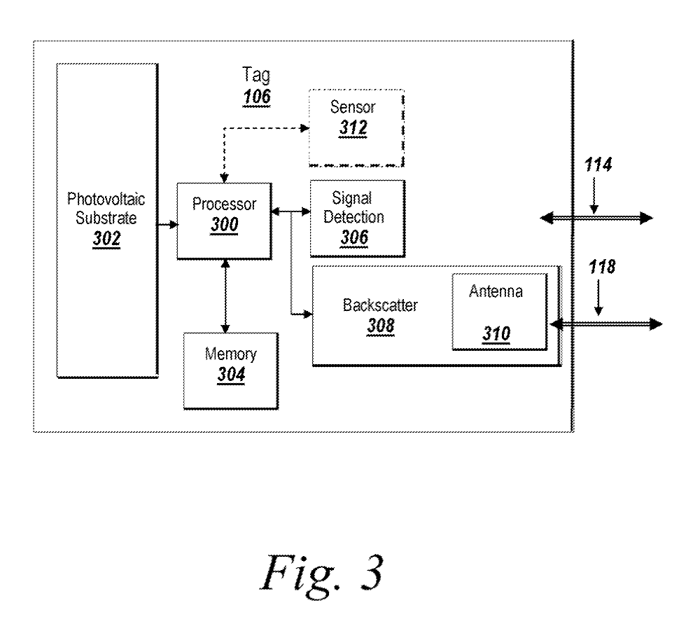

With reference to FIG. 3, an embodiment of a tag 106 for use in identifying an object is shown and described. The tag 106 includes a processor 300, a photovoltaic module, 302, a memory module 304, a signal detection module 306, a backscatter module 308, an antenna 310, and an optional sensor 312. In other embodiments, the various combinations of the above-listed modules along with additional modules that are not shown are combined in various ways.

The photovoltaic module 302 is in communication with the processor 300. The signal detection module 306 and the backscatter module 308 communicate with the processor module 300. The memory module 304 also communicates with the processor module 300. The antenna 310 communicates with the backscatter module 310.

In one exemplary embodiment, the tag 106 is an application specific integrated circuit (ASIC). The embodiment of the tag ASIC consists of an oscillator, solid state data storage (memory), a microcontroller apparatus used to perform computation on data, operate peripheral components, manage data storage and manage communication with external devices requesting information. The processor apparatus 300 includes, alone or in combination, one or more of a microprocessor core, dedicated microprocessor, Field Programmable Gate Array, application specific gate logic, Finite State Machine (FSM) and the like. The ASIC also supports a plurality of data encryption and decryption schemes.

As an overview, in operation the reader 102 irradiates the tag 106 or another light emitting source (e.g., ambient light) irradiates the tag. In response, the photovoltaic module 302 receives and transforms the impinging light into electrical energy that is used to provide power to the tag 106. The processor 300, memory module 304, signal detection module 306, backscatter module 308 and antenna 310 use the harvested power to process and store data transmitted by the light source or to activate the backscatter modulation module 308 to respond to an interrogation from the reader 102. For example, an electronic product code (EPC) is backscattered to the reader in response to the reader 102 irradiating the tag 106 and requesting such data.

In some embodiments, the tag 106 is capable of recovering light energy from the light beam from the reader 102 impinging on the tag 106 surface area. The light energy from the reader 102 powers the tag 106 processor 300, memory 304, signal detection 306, and backscatter 308 modules.

In one embodiment, the processor 300 is a microcontroller constructed as an application specific integrated circuit (ASIC). In other embodiments, the processor 300 is a field programmable array (FPGA), an integrated circuit chip, or digital signal processor all of which can also be thought of as ASICs. In other embodiments, a general purpose processor having application specific instructions can also be used. The processor 300 executes instructions that are stored, for example, in the memory module 304 of the tag 106. The instructions provide functionality such as signal detection, modulation and demodulation, encryption and decryption, receive and transmit commands as well as additional functionality not specifically listed.

In one embodiment, the processor 300 controls the peripheral modules 304, 306, 308, computes the state of the tag 106, executes instructions to decode an encoded query converted as an optical digital signal from the reader 102, executes the reader 102 query encoded in the digital input signal, access and read, or write, to the adjoining memory bank 304, encodes a response for the reader 102 query, and passively transmits the response through the backscatter 308 module.

In one embodiment, the photovoltaic module 302 is constructed from one, or a combination, of the plurality of materials that transform light energy into an electric potential. The electric potential is used to power the tag 106 circuitry. For example, the photovoltaic substrate 302 includes one or more photovoltaic materials including, but not limited to, silicon PN junctions, organic polymers, GaAs substrates and any other material that is compatible with the implementation of an integrated circuit.

In another embodiment, the photovoltaic substrate 302 includes materials capable of converting light energy from a plurality of light wavelengths. For example, visible light and adjacent wavelengths can be used to power tag 106.

In another embodiment, the photovoltaic substrate 302 includes the plurality of photosensitive materials where the latency of optical activation and decay provides a coherent and stable definition of a digital signal.

The photovoltaic module 302 can also include power-conditioning circuitry to filter the impingent light signal and define a steady coupling with the tag 106. The direct current (DC) component of the light signal is used as the steady state power source for the tag 106. The alternating current (AC) component of the modulated light signal is determined to be a modulated data signal that is further conditioned by performing an analog to digital conversion (ADC) to extract the transmitted data.

In one embodiment, the memory module 304 includes, alone or in combination, one or more of an EEPROM, a ROM, a PROM, a RAM, a SRAM, and the like. The memory module 304 stores program instructions for the processor 300 to control the memory 304, signal detection 306, and backscatter modulation 308 modules. The memory module 304 can also store the EPC code for the tag 106.

In one embodiment the memory module 304 stores processor 300 instructions to decrypt and encrypt data exchanged with reader 102. In another embodiment the encrypted data is stored persistently in the memory module 304.

In one embodiment the instructions executed by the processor 300 control the signal detection module 306 to process the signals in both the digital and analog domains. For example, one or more analog signal filters in the signal detection module 306 are accessed by the processors 300 and further analyzed to recover the data digitally encoded on the light signal.

In one embodiment, the signal detection module 306 receives encoded modulated optical signal from the reader 102 and operates in cooperation with the processor 300 to analyze and decode the received signal. For example, the incident light can be encoded using one or more of a plurality of schemes including Miller encoding, Manchester encoding, bi-phase encoding amongst others.

In one embodiment, the specific implementation of the modulation scheme for both the light signal sent from the reader 102 to the tag 106 and the backscatter modulated RF signal sent from the tag 106 to the reader 102 is time synchronized to define the resolution of the sampling window available to the tag 106. The time synchronization is calculated from the rate at which the reader 102 issues data, the clock frequency of the tag 106 and an encoding of the data transmitted from the reader 102, that facilitates the recovery of legitimate normalized data blocks. An example of synchronization is to use an encoding of the data on the carrier signal that is DC balanced whereby the reader 102 and tag receiver 106 can be phase locked.

In one embodiment, when the tag is in an environment providing adequate ambient light to power the tag 106, the signal detection module 306 and embedded software will determine that the tag 106 should not activate in the absence of structure modulated light that forms a valid enquiry or other digitally formed optical structure or digital instruction.

Backscatter module 308 can include active and passive RF circuitry and is also referred to as an RF module throughout the specification. For example, in one embodiment the backscatter module 308 includes a RF antenna 310 that is tuned to the frequency of the RF module's 208 emitted signal whereby RF signals from the reader 102 are detected and reflected by the tag 106 in a way that the RF module 208 can detect the reflected signal. This process is called carrier wave backscatter modulation.

In one embodiment, the antenna 310 is a patch antenna. The antenna 310 can be any type of an antenna element. For example, the antenna 310 can be, but is not limited to, a patch antenna, a waveguide slot antenna, a dipole antenna, and the like. In some embodiments, the tag 106 includes two or more different types of antennas. In some embodiments, one or more of the antennas includes a plurality of antennas (i.e., an array of antenna elements). In some embodiments, if multiple antennas are used, the antenna can be multiplexed.

In some embodiments, the tag 106 includes an optional sensor module 312. The sensor module 312 can be any of a variety of transducing devices that can detect the presence or absence or activity of substances such as gases and fluids, chemical, biologic, other reactive materials, and the like. In another embodiment the sensor module 312 includes a variety of transducing devices that respond to physical measurements such as temperature, pressure, light, radioactivity and the like. In other embodiments, other types of sensors can be used. Also various combinations of sensors 312 can be included on the tag 106. The sensor module 312 sensing one or more characteristics of the environment in which the tag is deployed.

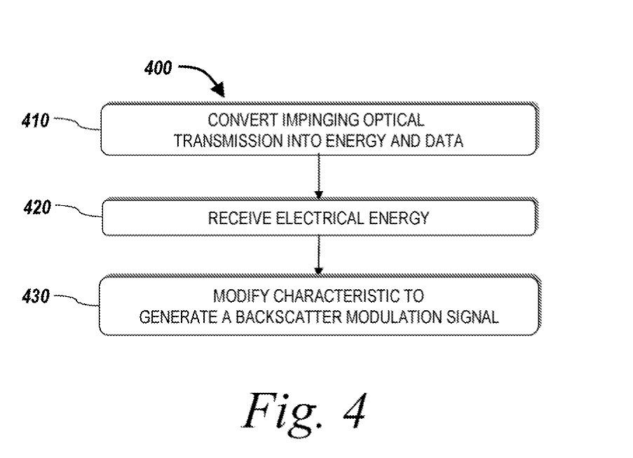

With reference to FIG. 4, a method 400 of operating a tag is shown and described. In one embodiment, the method includes converting (step 410) an impinging optical transmission into electrical energy and data, receiving (step 420) the converted electrical energy by one or more components of the tag 106, and modifying (step 430) a characteristic of the tag 106 to generate a backscatter modulation signal.

In one embodiment, the photovoltaic module 302 converts (step 410) an impinging optical transmission received from the reader 102 into electrical energy and data. The impinging optical transmission can include data modulated onto a light carrier wave. The optical transmission can be used to program portions of the tag 106 and send data to the tag 106. The data signal can be analog or digital in nature. Also, the data signal can be converted between an analog state and a digital state. Also, the impinging optical transmission is used to provide electrical power to other components of the tag 106.

In one embodiment, the processor 300 receives (step 420) the converted electrical energy and executes instructions. The instructions executed by the processor can control and command the various components of the tag 106. The instructions can be stored internally at the processor 300 or in the memory module 304. Also, the instructions can be stored in a combination of locations. Also, the processor can demodulate the data signal received as part of the impinging optical transmission to extract the data therein.

In one embodiment, the backscatter module 308 modifies (step 430) a characteristic of the tag 106 to generate a backscatter modulation signal. The processor commands one or more components of the backscatter module to modulate the impedance of the antenna 310 to generate a backscatter modulation signal. The signal can be an RF signal that is internally generated by the tag 106. In another embodiment, an input RF signal is received by the tag 106 and modulated by the RF module 308.

In other embodiments, the method also includes sensing a characteristic of an environment in which the tag is deployed. That characteristic can include the presence or absence or activity of substances such as gases and fluids, chemical, biologic, other reactive materials, and the like. Also, that characteristic can include a physical measurement such as temperature, pressure, light, radioactivity and the like.

Also, the method can include detecting the presence of a signal prior to the modifying the characteristic of the RF module. For example, in addition to receiving an impinging optical transmission, an input RF transmission may also be needed to active the tag 106. In such an embodiment, the input RF can be modulated by the backscatter module 308 to generate the backscatter modulation signal.

Although the systems and methods described above occur with reference to specific details, it is not intended that such details should be regarded as limitations upon the scope of the application, except as and to the extent that they are included in the accompanying claims.

What is claimed is:

1. A tag comprising:
a photovoltaic module that receives an impinging optical transmission and converts at least a first portion of the optical transmission into electrical energy and a second portion of the optical transmission into data; and
an RF module in communication with the photovoltaic module, the RF module receiving the electrical energy from the photovoltaic module and in response modifying a characteristic of the RF module to generate a backscatter modulation signal.

2. The tag of claim 1 wherein the characteristic of the RF module comprises an impedance of an antenna.

3. The tag of claim 1 further comprising a processor in communication with the photovoltaic module and the RF module, the processor receiving at least a portion of the electrical energy and in response executing instructions to control the characteristic of the RF module.

4. The tag of claim 3 wherein the processor comprises an application specific integrated circuit.

5. The tag of claim 3 further comprising a sensor module in communication with the processor.

6. The tag of claim 3 further comprising a signal detection module in communication with the processor, the signal detection module detecting the presence of a signal.

7. The tag of claim 3 further comprising a memory module in communication with the processor.

8. A method for operating a tag, the method comprising:
converting, by a photovoltaic module, at least a first portion of a received impinging optical transmission into electrical energy and at least a second portion of the received impinging optical transmission into a data signal;
receiving, by an RF module, the electrical energy; and modifying a characteristic of the RF module to generate a backscatter modulation signal.

9. The method of claim 8 wherein modifying a characteristic comprises modifying an impedance of an antenna of the RF module.

10. The method of claim 8 further comprising demodulating the data signal.

11. The method of claim 8 further comprising:
receiving, by a processor module in communication with the photovoltaic module and the RF module, at least a portion of the electrical energy; and
executing instructions to control the characteristic of the RF module.

12. The method of claim 11 wherein receiving comprises receiving by an application specific integrated circuit.

13. The method of claim 11 wherein executing instructions comprises, executing instructions stored in a memory module of the tag.

14. The method of claim 8 further comprising sensing a characteristic of an environment in which the tag is deployed.

15. The method of claim 8 further comprising detecting the presence of a signal prior to the modifying the characteristic of the RF module.

16. A system for operating a tag, the system comprising:
means for converting at least a first portion of a received impinging optical transmission into electrical energy;
means for converting at least a second portion of the impinging optical transmission into a data signal;
means for receiving the electrical energy; and
means for modifying a characteristic of the RF module to generate a backscatter modulation signal.

17. The system of claim 16 wherein the means for modifying comprises means for modifying an impedance of an antenna of the RF module.

18. The system of claim 16 further comprising means for executing instructions to control the characteristic of the RF module.

19. The system of claim 18 further comprising means for storing instructions.

20. The system of claim 16 further comprising means for sensing a characteristic of an environment in which the tag is deployed.

21. The system of claim 16 further comprising means for detecting the presence of a signal prior to the modifying the characteristic of the RF module.
